(19) United States
(12) Patent Application Publication
(10) Pub. No.: US 2004/0013416 A1
(43) Pub. Date: Jan. 22, 2004

(54) Optical disc player

(76) Inventor: Kyung-Tae Mok, Seoul (KR)

Correspondence Address: McGuireWoods LLP, Tysons Corner, 1750 Tysons Boulevard, Suite 1800, McLean, VA, 22102-4215, US

(21) Appl. No.: 10/445,204

(22) Filed: May 27, 2003

(30) Foreign Application Priority Data
May 24, 2002 (KR) 2002-0029049

(51) Int. Cl. H04N 5/781

(52) U.S. Cl. 386/125; 386/126

(57) ABSTRACT

An optical disc player includes an optical pickup unit; a signal processor for extracting streams from a signal read by the optical pickup unit, a demultiplexer for dividing streams received from the signal processor into sub-streams for every data, an audio decoder for decoding audio data received from the demultiplexer, a video decoder for decoding video data received from the demultiplexer, an OSD (On-Screen-Display) processor for processing OSD data received from the demultiplexer, a data output unit for outputting resultant data processed at the audio decoder, the video decoder, and the OSD processor, and a controller for controlling overall operations of the aforesaid components. The controller executes an application program upon receiving a contents view request signal from a user, reads meta data files needed for controlling playback of contents upon receiving a control signal of the application program and a user's request signal, gains access to MPEG still images needed for playback of media data contained in the meta data files upon receiving access information associated with media data of the meta data files, outputs resultant images to the video decoder, and outputs graphic data to the OSD processor.

### CROSS REFERENCE TO RELATED APPLICATION

This application claims the benefit of Korea Application—No. 20002-0029049, filed on May 24, 2002, which is hereby incorporated by reference for all purposes as if fully set forth herein.

### BACKGROUND OF THE INVENTION

1. Field of the Invention

The present invention relates to a media player, and more particularly to an optical disc player for reproducing media data recorded by laser light, which enables a user not only to easily view additional information on the media data to be played, but also to search for contents stored on the optical disc.

2. Description of the Related Art

Recent rapid growth of demands on multi media and wide spread of media recording and play system have increased the needs of users to effectively search for data recorded on various media. Therefore, a number of storage devices have been developed to store large amounts of data to satisfy the user's demands as described above. Further, media players have been developed for reproducing the data stored in the storage media. A few examples are DVD (Digital Versatile Disc) or VCD (Video Compact Disc) players.

However, when such media players reproduce data recorded on various media, such as audio data in MP3 files, they can only provide a too simple user interface, like displaying the list of files, etc. They cannot provide the users with other services, such as displaying image files or text files. In order to process still-images of digital photos or cartoon animations, a conventional player uses a set-top box to decode JPEG data and then outputs the decoded images on the screen. Such an approach is pretty expensive. When processed by software, it requires lots of calculation and slows the process. On the other hand, using a dedicated hardware decoder would increase the costs

When conventional players search for media data from the storage device, using an index search or navigation technologies, they only support 256 colors for on screen display (“OSD”). Therefore, display of true-color images such as music album jacket pictures or thumbnail images as OSD would noticeably deteriorate the data playback speed and the quality of image.

### SUMMARY OF THE INVENTION

The present invention addresses such problems. The present invention is directed to an optical disc player that enables users to view or hear image files, music files, and e-book (electronic book) files using a DVD or VCD player having MPEG/MPEG-2 chips, without additional costs in hardware and without sacrifice in playback speed or reproduction quality.

The present invention also allows the users to easily search for a variety of contents and associated additional information using a DVD or VCD player, providing greater convenience with the users of viewing the contents.

Such advantages of the present invention can be accomplished by dividing the information streams from the signal processor into sub-streams of each set of data. From such sets of data, the present invention retrieves meta file and initialize the data in the file to display OSD according to the user input.

Preferably, the optical disc player can provide a user with contents data providable from a set-top box of a HDD (Hard Disc Drive) built-in type, for example, image files or electronic books, using a general DVD player without incurring additional costs in hardware, such that the optical disc player upgrades its software version without upgrading its hardware version. Also, a meta data file includes additional information of individual contents and navigation information needed for finding desired contents data is adapted to more conveniently and easily search for still images such as digital photo images or e-book data in a common DVD player.

Preferably, the media data may further include digital audio data, and the controller may control the digital audio data to be transmitted to the audio decoder.

Preferably, the optical disc player can enable a user to easily search for his or her desired data by upgrading only a software version without incurring additional costs in hardware, as compared to provide the user with MP3 music file playback services using a conventional DVD player. Additional information associated with the music files may be supplied to the user, improving the user interface.

### BRIEF DESCRIPTION OF THE DRAWINGS

The above mentioned features and other advantages of the present invention will be more clearly understood from the following detailed description taken in conjunction with the accompanying drawings.

FIG. 1 is a block diagram illustrating an optical disc player in accordance with a preferred embodiment of the present invention.

FIG. 2 is a flow chart illustrating a method for reproducing data of digital audio file using the optical disc player of FIG. 1 in accordance with the present invention.

FIGS. 3, 4, 5, 6, 7, 8, 9 and 10 are exemplary views illustrating screen capture images of contents being recorded on an optical disc by the optical disc player of FIG. 1 in accordance with the present invention.

### DESCRIPTION OF THE PREFERRED EMBODIMENTS

Now, embodiments of the present invention will be described in detail with reference to the drawings. In the drawings, the same or similar elements are denoted by the same reference numerals even though they are depicted in different drawings. In the following description, a detailed description of known functions and configurations incorporated herein will not be repeated.

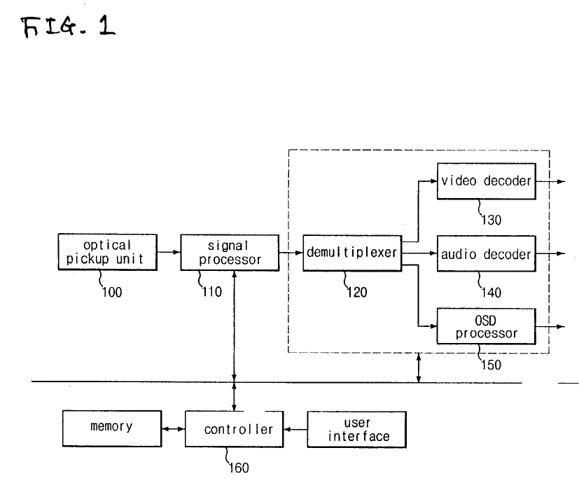

FIG. 1 is a block diagram illustrating an optical disc player in accordance with a preferred embodiment of the present invention. Referring to FIG. 1, an optical disc player according to the present invention includes an optical pickup unit 100, a signal processor 110 for processing signals read through the optical pickup unit 100, a demultiplexer 120, an audio decoder 140, a video decoder 130, an OSD processor 150, an output unit, and a controller 160. The optical disc player further includes a memory and a user interface. The aforementioned hardware components contained in the optical disc player are similar to a general DVD player. One of ordinary skill in the art could easily figure out each of the components.

The optical disc player of such components will hereinafter be described in light of the controller 160 of FIG. 1.

It should be noted that the optical disc player has a data recording system and a data reproducing system for both DVD and CD such that not only DVDs but also other optical storage media such as CDs can be played back by the optical disc player. One example of the optical disc player according to the present invention is such a DVD player. However, the optical disc used in the optical disc player may be a variety of discs such as DVDs or CDs that can be played in the DVD player. True-color screen images of navigation images, menu images, and detailed view images presented as thumbnail images, are respectively stored on the optical disc as an MPEG I-frame. In this case, other information associated with the above-identified images, for example, thumbnail locations and page up/down icons, selected by a remote controller upon receiving a user's request, are separately stored on the optical disc.

The MPEG I-frame is a part of MPEG standards. Therefore, it can display true-color. The compression file of a still image formatted in the MPEG I-frame is not much different from a JPEG file that is widely used for displaying a still image either size wise or quality wise. Therefore, a user can use the MPEG I-frame for viewing the still image.

The optical disc player according to the present invention plays back the data stored in such media. Referring to FIG. 1, upon receiving a contents view request from a user, the controller 160 executes an application program. Then, the application program reads meta data files. The meta data files are necessary for controlling playback of contents upon according to the user inputs. According to the access information on the media data that was included in the meta data files, it retrieves and sends the MPEG still images accesses MPEG still images needed for playback of media data contained in the meta data file upon receiving access information associated with media data of the meta data files, outputs resultant images to the video decoder 130. The video decoder outputs the graphic data to the OSD processor 150. Meta data files are described in detail in a U.S. patent application filed together with the present application, titled “Method for Editing and Processing Contents File and Navigation Information,” assigned to the same assignee of the present application, which is hereby incorporated by reference for all purposes as if fully set forth herein.

Therefore, the optical disc player according to the present invention plays back such media data stored on the optical disc, according to a control signal from the controller 160. It uses the video decoder 130 or the OSD processor 150 contained in the DVD player, depending on the types of contents stored on the optical disc.

The controller 160 uses the MPEG video decoder 130 for decoding MPEG video data that was stored in an MPEG I-frame. As a result, the optical disc player of the present invention can display high-quality images pretty quickly.

Further, when the media data recorded in the storage device is in digital audio format such as MP3 or WMA (Windows Media Audio), the controller 160 sends the media data to the audio decoder 140 of the DVD player, and plays back the audio. However, it should be noted that the optical disc player according to the present invention can be used not only for such specific data format as MP3, but for any digital audio data format. Thus, the present invention can further provide users with a variety of user interfaces and sufficient information using a minimum number of components, such as a CPU or memory, etc., in an apparatus for reproducing such digital audio data.

Therefore, the controller 160 according to the present invention enables users to more easily search for the list of data recorded on the optical disc using the meta data, when controlling the data playback of the optical disc player. This is a great advantage over the conventional DVD player.

Such meta data includes additional information on the individual contents. For example, if the storage device contains a music file, additional information may include album information, song information, and labels, etc. and navigation information that may be necessary for searching contents. In more detail, thumbnail navigation information, such as a music album jacket image, a title photo among a bundle of photo images, and illustrations associated with text files, can be contained as the additional information on individual contents.

Therefore, the optical disc player according to the present invention retrieves access information on the media data contained in the meta data. For example, when a contents file includes an MP3 file, the optical disc player gains access to image data and audio data. Here, the image data is usually music album jacket image and functions as a background image or thumbnail images that can be selected using a remote controller. Also, graphic data includes navigation information indicating locations and sizes to be highlighted upon user requests, as well as music title, song data, artists' name, and lyrics. Audio data includes sound. In this case, the navigation information is displayed as contents of the background image. The optical disc player according to the present invention enables a user to search for or reproduce his or her desired data using user's desired grouping methods based on albums, fields, artists, play lists, and other categories.

On the other hand, if such a contents file is an electronic album, the optical disc player gains access to image data, detailed description text associated with the image data, and graphic data. Herein, the image data is a photo or animation image, and the graphic data contains a detailed description text associated with the image data, and navigation information adapted to indicate highlight locations and sizes, etc., upon receiving a user's request.

Provided that the contents file is a text contents file having an e-book (Electronic book), the optical disc player accesses image data serving as a background image containing therein a book cover or illustration images, etc., or accesses graphic data having a contents text of the image data. Briefly, the optical disc player reads a text file from media, displays the read text file on an OSD area, and provides a user with a bookmark function to directly move the user to a specified location such as a specified Uniform Resource Locator (URL). In this case, the bookmark function allows a user to directly access a corresponding contents file using a page number, a percentage location relative to the whole document, or a user-defined bookmark. If the contents file is a text file such as a diary, the optical disc player enables users to view corresponding contents by dates.

Image data and graphic data associated with individual contents can be a background image composed of a plurality of still images, and include navigation information of image locations and sizes for image areas of prescribed items highlightable by a user's request for executing a navigation function.

Thus, the optical disc player according to the present invention can display a plurality of pictures on one display screen at the same time. Although there are a large number of thumbnails on such one display screen, high-quality images can be used for user interfaces. The MPEG video decoder decodes an MPEG I-frame containing such a background image. If a user selects his or her desired item using a remote controller, the selected item is boxed around the thumbnails, and is highlighted or indicated as simple icons in the vicinity of thumbnails. Such graphic information can be separately managed by the OSD processor 150.

Therefore, the optical disc player according to the present invention is able to reproduce data of music files such as MP3 files, data of image files such as real photos, and data of text files such as novels, is also able to easily search for a variety of contents recorded on media means through the use of meta data composed of additional information of the contents and navigation information needed for finding desired contents, and is able to provide users with various additional information, improving the user interface.

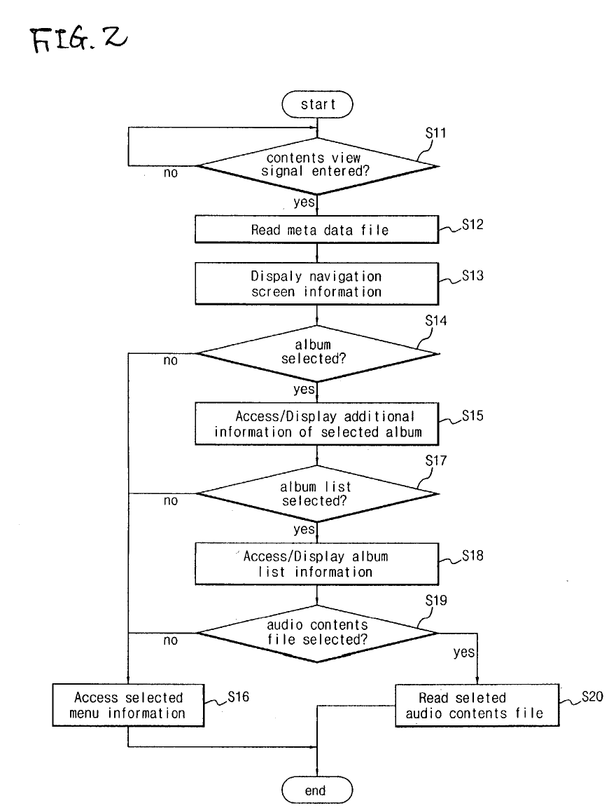

A method for reproducing audio contents recorded on an optical disc through the use of such an optical disc player will hereinafter be described with reference to FIG. 2. FIG. 2 is a flow chart illustrating a method for reproducing data of digital audio file using the optical disc player of FIG. 1 in accordance with the present invention.

The optical disc player executes a program stored in a memory upon receiving a contents view request from a user. If the user inputs the contents view request at step S11, the controller reads in meta data recorded on the optical disc at step S12. Therefore, the controller contained in the optical disc player obtains a file name of an MPEG I-frame of album thumbnails needed for navigation information contained in meta data, reads a corresponding file from the media, and decodes the file using the video decoder. The decoded images are displayed as navigation screen information on an output display screen at step S13. In this case, user interface (UI) selection information displayed on an OSD using meta data, for example, font size information and location information on a display screen, etc., are obtained and displayed on the OSD area at step S13.

In this way, if a user selects an album by moving a selection box using the user interface at step S14, the controller of the player gains access to additional information of the selected album using meta data of the selected album, and displays the additional information of the selected album on the OSD at step S15. However, if the user does not select the album at step S14, the controller gains access to information associated with a user selection menu, for example, navigation information, and additional information or file at step S16.

In the case of audio contents, additional information includes text file name information. This text file name information contains song information (e.g., title song data, lyrics, and audio files, etc.) and album information (e.g., an album title name, an album issue date, and an MPEG I-frame file name of the issued album). In the case of electronic album contents, the additional information includes album information (e.g., an album title and an album issue data, etc.). In the case of photo contents, the additional information includes image information (e.g., a photo-captured date, memorandum information, and an MPEG I-frame file name, etc.). In the case of text contents, the additional information includes a book name, a publishing company, an author, a publication date, and author profile, etc.

Then, if a user selects a signal for selecting one of album lists at step S17, the controller of the player gains access to album list information using meta data of the selected album, and displays the album list information on a display screen at step S18. Otherwise, if another signal instead of the album selection signal is selected by the user at step S17, the controller gains access to information associated with the user selection menu, for example, navigation information, and additional information or file at step S16.

If the user selects his or her desired song using the user interface at step S19, the controller begins to reproduce an audio contents file selected by such meta data at step S20. Although the present invention describes a playback method for the selected audio contents file, it should be noted that overall lists displayed on a screen in relation to such audio contents files are capable of being sequentially read in the optical disc player of FIG. 1. On the other hand, if another signal instead of the audio contents file selection signal is selected by the user at step S19, the controller gains access to information associated with the user selection menu, for example, navigation information, and additional information or file at step S16.

The above-identified optical disc player according to the present invention terminates the aforementioned control routines upon receiving a program termination command from the user.

FIGS. 3, 4, 5, 6, 7, 8, 9 and 10 are exemplary views illustrating screen capture images of contents being recorded on an optical disc by the optical disc player of FIG. 1 in accordance with the present invention. Referring to FIG. 3 showing a navigation display screen, representative images for 8 albums are mixed with one another on the navigation display screen, and album title information is additionally contained in each representative image. Therefore, if the user requests the optical disc player to reproduce data recorded on the optical disc, or requests the optical disc player to visually view the navigation display screen, an exemplary navigation display screen shown in FIG. 3 is displayed on a display, such that the user can directly recognize data of contents files recorded on the optical disc.

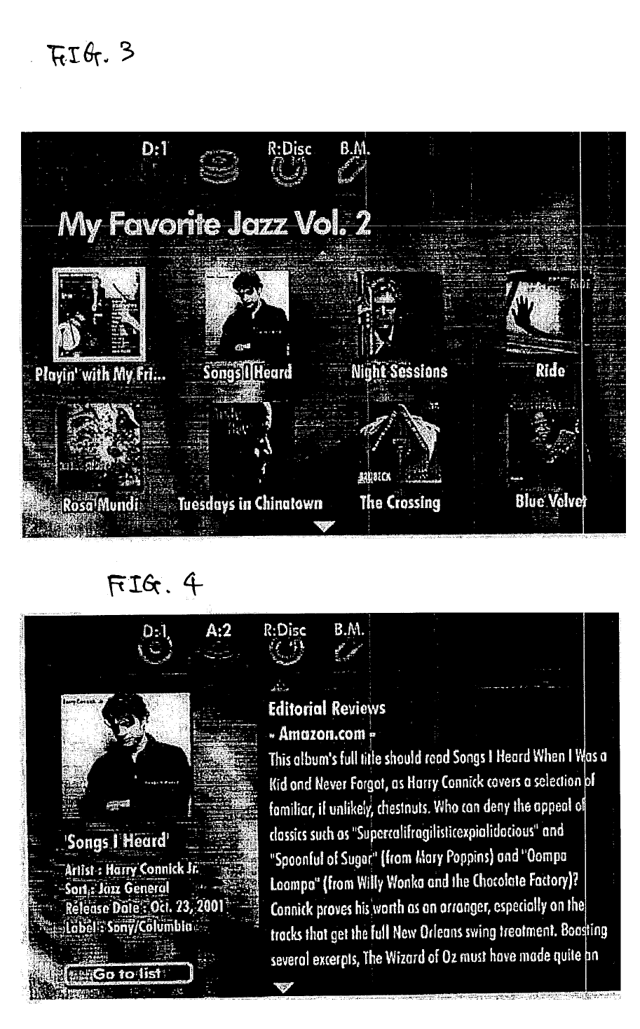

Provided that the user selects a “Songs I Heard” album from among a plurality of albums shown in FIG. 3, the controller of the optical disc player gains access to additional information of the selected album by referring to meta data file of the selected album, and controls the display to visually output the additional information as shown in FIG. 4. Therefore, as shown in FIG. 4, the user can visually view such additional information, e.g., a genre (or classification), a publication year, an artist name, and a publishing company of the “Songs I Heard” album, and can also receive an additional description associated with the album.

When the user selects a “Go to List” button of FIG. 4 to visually view the list of detailed audio contents files recorded on the “Songs I Heard” album, the list of audio contents files is displayed as shown in FIG. 5. It should be noted that the list of audio contents files is configured on the basis of access information contained in a meta data file. Therefore, in the case where a user selects a specified audio contents file on a display screen shown in FIG. 5, and request the player to reproduce the selected audio contents file, the controller of the player searches for location information of the selected audio contents file by referring to the meta data file, and reproduces data of a corresponding file, such that the user can hear the selected audio contents file.

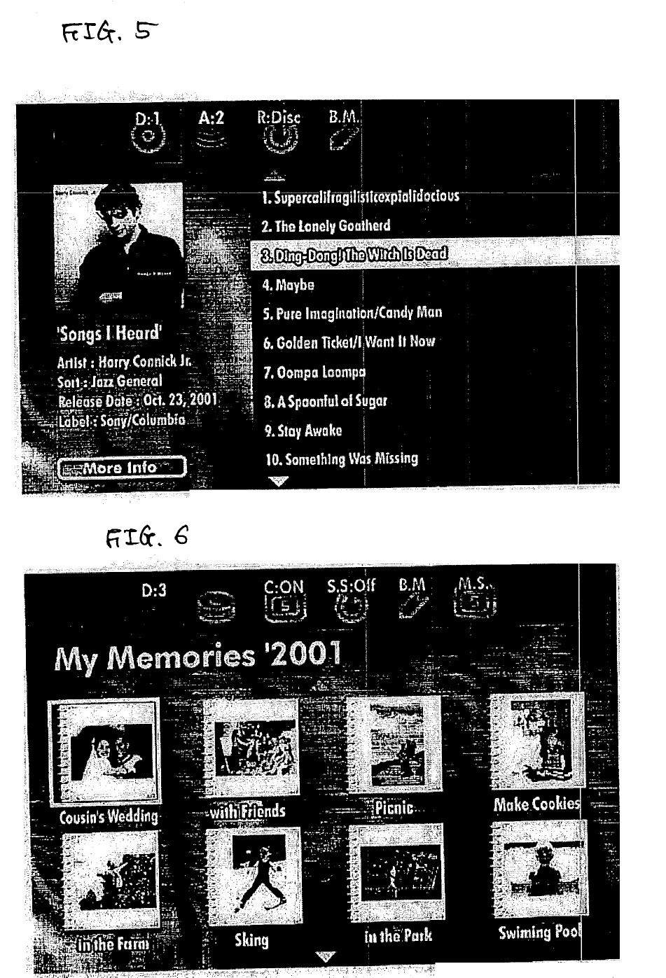

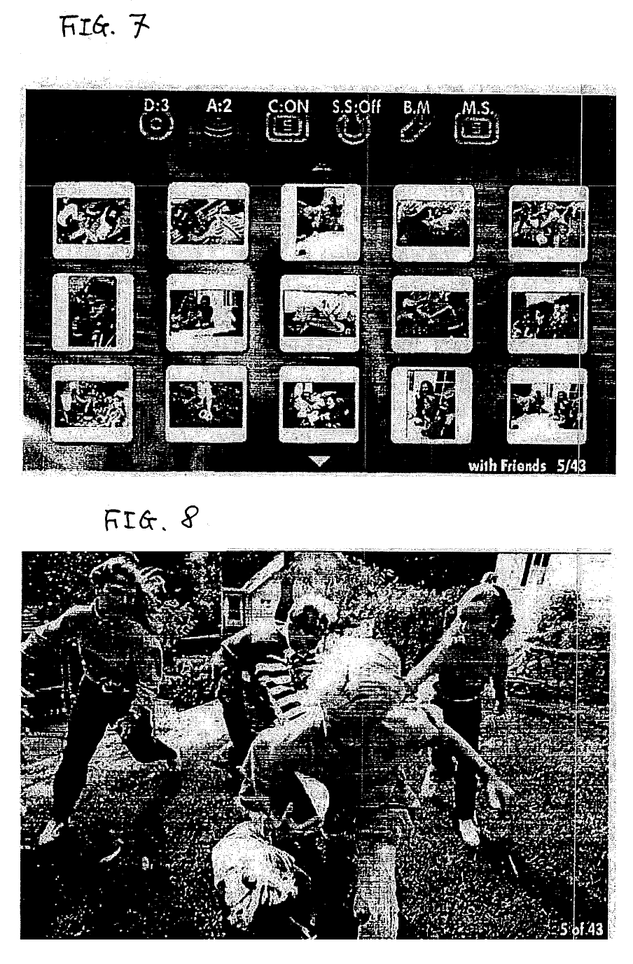

FIG. 6 is an exemplary view illustrating a navigation display mode that photo images are arranged as an album. This navigation display screen includes 8 album titles and their representative images, as shown in FIG. 6. If a “with friends” album is selected on the photo-album navigation display screen shown in FIG. 6, a plurality of image contents files recorded on the “with friends” album are displayed as shown in FIG. 7.

If one of image contents files shown in FIG. 7 is selected, a large-size photo image shown in FIG. 8 is displayed on a screen. If the user selects an additional information view function of the selected photo image, additional information of the selected photo image, for example, a place, date, and comments, can be overlapped with the selected photo image. Such sequential image contents files or additional information access can be accomplished using the meta data files.

Although the present invention describes a playback method of a selected video contents file, this playback method of the video contents file may control image contents as a background image using a digital video decoder depending upon a program type, and may sequentially and automatically display a plurality of images stored in a memory in the form of a slideshow.

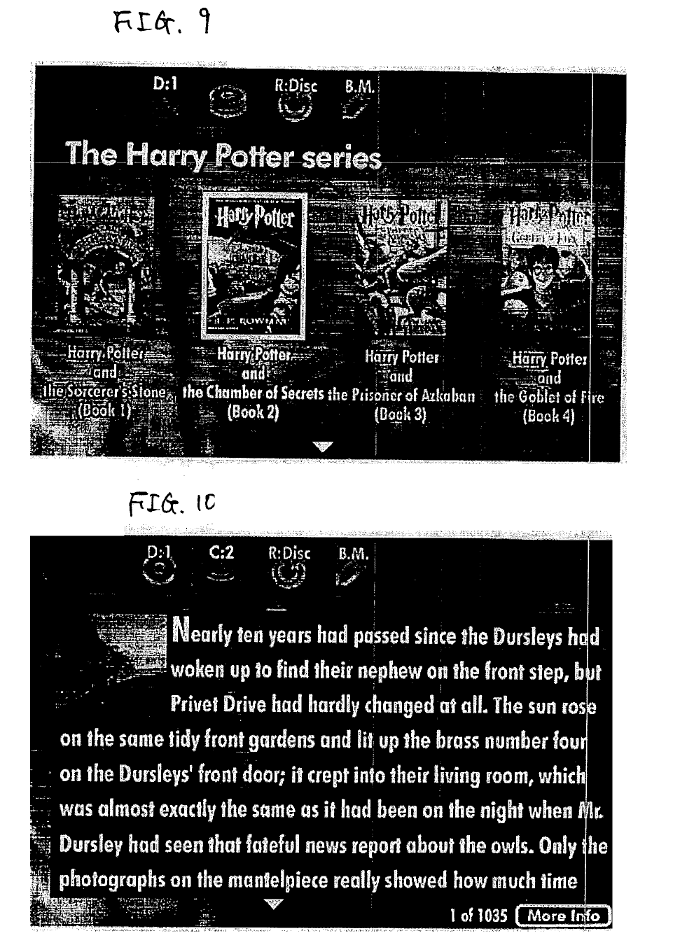

FIG. 9 is an exemplary view illustrating a display screen that an electronic book (e-book) file being one of text contents is arranged like an album. A navigation display screen of such text contents album contains four representative albums. FIG. 10 shows text contents, when selectively reproducing individual representative images.

As a result, when using the optical disc player according to the present invention, a user can directly and visually recognize files recorded on an optical disc, and at the same time can easily access the files and additional information recorded on the optical disc.

As apparent from the above description, an optical disc player according to the present invention enables users to view or hear image files, music files, and e-book (electronic book) files using a DVD or VCD player having MPEG/MPEG-2 chips, without additional costs in hardware.

The optical disc player enables users to easily search for a variety of contents and associated additional information using meta data of the optical disc for use in a DVD or VCD player, making it much more convenient for the users to view the contents.

Further, the optical disc player enables users to directly and visually recognize files contained in the optical disc using thumbnails of representative images contained in the meta data file, and at the same time easily provides the users with the files or additional information recorded on the optical disc.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical disc player, comprising:
an optical pickup unit;
a signal processor for extracting streams from a signal read by said optical pickup unit;
a demultiplexer for dividing streams received from said signal processor into sub-streams for every data;
an audio decoder for decoding audio data received from said demultiplexer;
a video decoder for decoding video data received from said demultiplexer;
an On-Screen-Display (OSD) processor for processing OSD data received from said demultiplexer;
a data output unit for outputting data processed at said audio decoder, said video decoder, and said OSD processor; and
a controller for controlling overall operations of said optical disc player,
wherein said controller, upon receiving a contents view request from a user, reads a meta data file and displays images, and
wherein the meta data file comprises an MPEG still image.

2. The optical disc player of claim 1, wherein the meta data file further comprises image data, graphic data and audio data as well as media data.

3. The optical disc player of claim 2, wherein the controller accesses the MPEG still image associated with the media data and sends the MPEG still image to said video decoder and said the graphic data to said OSD processor.

4. The optical disc player of claim 3, wherein the media data further includes digital audio data, and
wherein the controller sends the digital audio data to said audio decoder.

5. The optical disc player of claim 4, wherein the media data are MP3 files, the image data is a background image, the graphic data include a title, an artist name, and lyrics, and the audio data includes sound source data.

6. The optical disc player of claim 4, wherein the still image data is in an MPEG I-frame format.

7. The optical disc player of claim 4, wherein the media data are arranged in the form of an electronic album, the image data include photo data, and the graphic data include texts of a detailed explanation on the photo data.

8. The optical disc player of claim 7, wherein the image data include a background image having a plurality of still images, the graphic data include navigation information indicating a specified image area.

9. The optical disc player of claim 4, wherein the media data are arranged in the form of an electronic book (e-book), the image data include a background image, and the graphic data include contents text data.

10. The optical disc player of claim 9, wherein the media data further includes digital audio data used for reading contents text data, and the controller controls the digital audio data to be transmitted to the audio decoder.

11. A method for playing back an optical disc, comprising:
determining contents view signal;
reading meta data file upon receiving the contents view signal;
displaying navigation screen information;
determining if an album is selected;
accessing information on the album selected and displaying the information;
determining if audio contents file is selected; and
reading the audio contents file selected.

12. The method of claim 11, further comprising:
accessing selected menu information if the conditions are determined to be negative.

13. A storage medium, wherein said storage medium includes a meta file.

14. The storage medium of claim 13, wherein the meta file includes navigational information as well as media files.
